(19) United States
(12) Patent Application Publication
(10) Pub. No.: US 2021/0118035 A1
(43) Pub. Date: Apr. 22, 2021

(54) GENERATION DEVICE AND NON-TRANSITORY COMPUTER READABLE MEDIUM

(71) Applicant: FUJI XEROX CO., LTD., Tokyo (JP)

(72) Inventors: Shotaro MISAWA, Kanagawa (JP); Tomoki TANIGUCHI, Kanagawa (JP); Masahiro SATO, Kanagawa (JP); Tomoko OHKUMA, Kanagawa (JP)

(73) Assignee: FUJI XEROX CO., LTD., Tokyo (JP)

(21) Appl. No.: 16/892,401

(22) Filed: Jun. 4, 2020

(30) Foreign Application Priority Data
Oct. 18, 2019 (JP) 2019-191397

(51) Int. Cl. G06Q 30/06; G06N 5/04; G06N 20/00; G06Q 30/02; G06F 40/30

(52) U.S. Cl. CPC G06Q 30/0631; G06N 5/04; G06N 20/00; G06F 40/30; G06Q 30/0276; G06Q 30/0255; G06Q 30/0269; G06Q 30/0623

(57) ABSTRACT

A generation device includes a processor. The processor is configured to input, into a learning model that has learned, using learning data in which user information of a user, a purchase history of the user regarding a product, product information of the product, and text associated with the product, the text being added to the product, are associated with one another, association of the user information, the purchase history, the product information, and the text included in the learning data, the user information of the user and product information of a recommended product recommended to the user, and generate text associated with the recommended product based on the purchase history of the user.

### CROSS-REFERENCE TO RELATED APPLICATIONS

This application is based on and claims priority under 35 USC 119 from Japanese Patent Application No. 2019-191397 filed Oct. 18, 2019.

### BACKGROUND

### (i) Technical Field

The present disclosure relates to a generation device and a non-transitory computer readable medium.

### (ii) Related Art

An advertisement text selection device is disclosed in Japanese Unexamined Patent Application Publication No. 2017-111479. The advertisement text selection device includes an advertisement text analysis unit that generates, for each of a plurality of pieces of advertisement text data corresponding to advertisement targets, an advertisement text vector representing characteristics of a word included in the advertisement text data, a user preference analysis unit that generates a user vector that represents characteristics of a word included in text related to electronic content used by a user, a cluster advertisement text extraction unit that performs clustering of the advertisement text vectors generated from the plurality of pieces of advertisement text data and extracts, for each of a plurality of clusters obtained by the clustering, advertisement text data in which an advertisement text vector similar to a center venter of the cluster is obtained from among the plurality of pieces of advertisement text data, and a user matching unit that selects a center vector similar to the user vector generated by the user preference analysis unit from among the center vectors of the plurality of clusters and selects, as advertisement text data that matches the user, the advertisement text data extracted by the cluster advertisement extraction unit for the selected center vector.

An information processing apparatus that acquires recommended content to be presented to a user and recommended additional information on the recommended content is disclosed in Japanese Patent No. 5746658. The information processing apparatus includes an additional information storing unit that stores additional information on content, a selection history storing unit that stores a selection history of the content and the additional information previously selected by the user, a first estimation unit that estimates first preference information representing tendency of preference of the user for the content, based on the selection history, a second estimation unit that estimates second preference information representing tendency of preference of the user for the additional information, and a selection unit that selects the recommended content and the recommended additional information based on the first preference information and the second preference information.

An information display device is disclosed in Japanese Patent No. 6543986. The information display device includes pre-processing means for converting, for product data including a product image and a product explanatory sentence, the product image and the product explanatory sentence into features and acquiring the feature of the product data including the features of the product image and the product explanatory sentence, learning means for performing machine learning on the feature of user data representing an attribute of a user who purchases a product and the feature of the product data and creating a model that has learned the correlation between the feature of the user data and the feature of the product data, and recommending means for acquiring feature data of the user data corresponding to a user who accesses a website where the product is purchased and the feature of the product data, calculating a matching degree by performing machine learning to which the model is applied, and determining a recommendation ranking of the product based on the matching degree.

### SUMMARY

To prompt user's buying motivation, for example, text associated with a product, such as an advertising slogan, may be displayed on the product.

However, users show interests in different advertising slogans, and it has thus been difficult to generate an advertising slogan in which each of the users shows an interest.

Aspects of non-limiting embodiments of the present disclosure relate to providing a generation device and a non-transitory computer readable medium that are able to generate text associated with a product for each user.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a generation device including a processor. The processor is configured to input, into a learning model that has learned, using learning data in which user information of a user, a purchase history of the user regarding a product, product information of the product, and text associated with the product, the text being added to the product, are associated with one another, association of the user information, the purchase history, the product information, and the text included in the learning data, the user information of the user and product information of a recommended product recommended to the user, and generate text associated with the recommended product based on the purchase history of the user.

### BRIEF DESCRIPTION OF THE DRAWINGS

Exemplary embodiments of the present disclosure will be described in detail based on the following figures, wherein:

FIG. 1 is a diagram illustrating an example of a functional configuration of a generation device;

FIG. 2 is a diagram illustrating an example of a history information table;

FIG. 3 is a diagram illustrating an example of the configuration of a principal part of an electrical system in a generation device;

FIG. 4 is a flowchart illustrating an example of the flow of a learning process performed by a generation device according to a first exemplary embodiment;

FIG. 5 is a flowchart illustrating an example of the flow of a generation process performed by the generation device according to the first exemplary embodiment;

FIG. 6 is a flowchart illustrating an example of the flow of a learning process performed by a generation device according to a second exemplary embodiment;

FIG. 7 is a diagram illustrating a learning example of a learning model in the second exemplary embodiment;

FIG. 8 is a flowchart illustrating an example of the flow of a generation process performed by the generation device according to the second exemplary embodiment;

FIG. 9 is a flowchart illustrating an example of the flow of an editing process; and

FIG. 10 is a diagram illustrating an execution example of the editing process.

### DETAILED DESCRIPTION

Hereinafter, exemplary embodiments will be explained with reference to drawings. The same components and processing operations will be referred to with the same signs throughout the drawings, and redundant explanation will be omitted.

### First Exemplary Embodiment

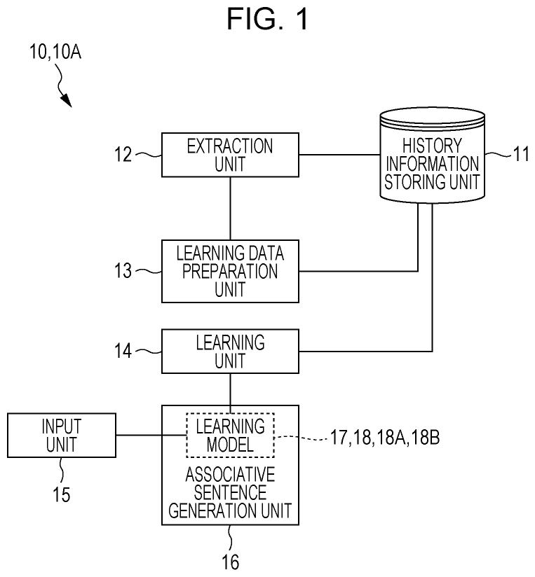

FIG. 1 is a diagram illustrating an example of a functional configuration of a generation device 10 according to a first exemplary embodiment. The generation device 10 includes functional units such as a history information storing unit 11, an extraction unit 12, a learning data preparation unit 13, a learning unit 14, an input unit 15, and an associative sentence generation unit 16. The associative sentence generation unit 16 includes a learning model 17 as a learning target.

The history information storing unit 11 stores history information in which an action taken by a user on a product presented to the user by an electronic commerce (EC) website displayed on an information device such as a desk top computer, a tablet terminal, or a smartphone via the Internet is recorded.

The history information includes, for example, user information of a user to whom product information is presented, the product information of a product presented to the user, text associated with the product, the text being displayed along with the product, and a purchase history of the presented product.

User information is information indicating a user. The user information may include identification information for identifying a user, such as a user identification (ID) or a membership number. Furthermore, the user information may include information of a user, such as name, age, address, sex, hobbies, and family structure of the user, in addition to the identification information for identifying the user.

Product information is information indicating a product. The product information includes identification information for identifying a product, such as the name and model of the product. Furthermore, the product information may include any type of information of a product, such as the price of the product (including price range), the degree of popularity of the product, information of an EC website on which the product is displayed, the period during which the product is displayed on the webpage of the EC website, the producer (manufacturer), the produced (manufactured) place, and an explanatory sentence describing the summary of the product, in addition to the identification information for identifying the product.

Text associated with a product is text for making a user impressed with the product, such as an advertising slogan for the product, and is also called an “associative sentence”. Hereinafter, the generation device 10 will be explained by using an advertising slogan for a product as a representative example of text associated with the product. An advertising slogan for a product may be an advertising slogan displayed on a label or the like attached to the product or an advertising slogan displayed along with an image of the product on the webpage of an EC website. In addition, a plurality of pieces of text associated with a product may be provided to the product or only a single piece of text associated with a product may be provided to the product.

A purchase history of a product is information indicating purchase of a product. Furthermore, a purchase history of a product may include an index value indicating the degree of user's interest in the product, such as the display time of a webpage on which the product is displayed, search or non-search for the product using a search engine, and the number of search times, as well as the purchase status of the product. The degree of user's interest in the product is an example of the degree of user's response to a product. The higher the degree of user's interest in a product, the higher the degree of user's response to the product. Furthermore, the degree of a user's interest on a product also represents information indicating the process of purchase of the product.

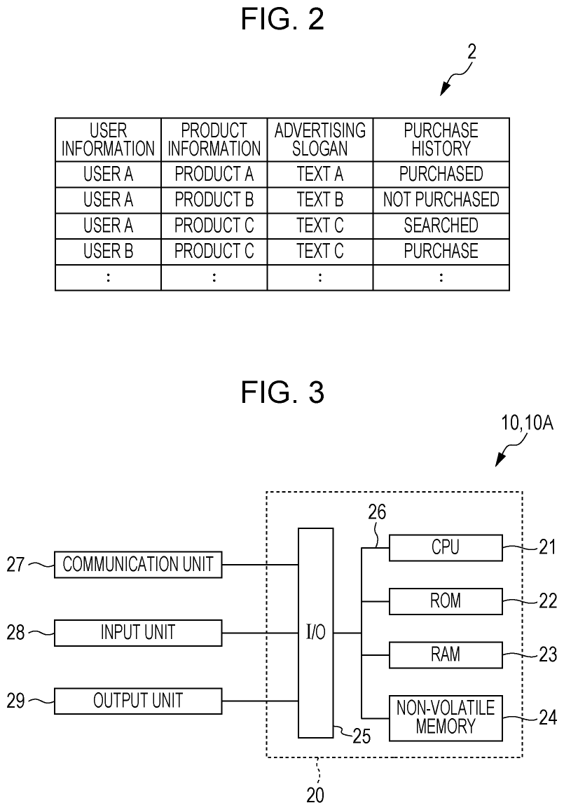

FIG. 2 is a diagram illustrating an example of a history information table 2 that manages history information. The history information table 2 illustrated in FIG. 2 includes, for example, history information in which an action taken by a user on a product browsed on a webpage is recorded. For example, a username is set as user information, and a product name is set as product information. Furthermore, in a purchase history field, “purchased” represents that a user purchased a product, and “not purchased” represents that a user did not purchase a product. “Searched” represents that a user searched for a product using a search engine. The history information table 2 may include other types of information such as record time at which history information was recorded in the history information table 2, in addition to the information illustrated in FIG. 2.

As described above, the history information storing unit 11 records, for each user, an action taken by the user on each product presented to the user.

The extraction unit 12 extracts, for each user, history information in which “purchased” is set as a purchase history, from among a plurality of pieces of history information recorded in the history information storing unit 11.

The learning data preparation unit 13 prepares, for each user, learning data in which user information, product information, an advertising slogan for a product, and a purchase history that are included in extracted history information are associated with one another.

The learning unit 14 causes, using learning data for each user prepared by the learning data preparation unit 13, the learning model 17 to learn association among the user, a product purchased by the user, and an advertising slogan. For example, the learning model 17 is structured with a neural network. By repeatedly performing machine learning in which user information and product information included in learning data are used as input data and an advertising slogan included in the same learning data as that including the input user information and product information is used as learning data, the learning model 17 is caused to learn association among a user, a product purchased by the user, and an advertising slogan for the product displayed when the user purchased the product.

The input unit 15 receives product information of a product recommended to a user (hereinafter, referred to as a “recommended product”) and user information of the user to whom the recommended product is presented. Specifically, the input unit 15 receives, for example, a product name of a recommended product and a username of a user to whom the recommended product is recommended. The input unit 15 does not necessarily receive user information.

When product information of a recommended product and user information are received by the input unit 15, the associative sentence generation unit 16 generates, using the learning model 17, an advertising slogan for the recommended product based on the product information of the recommended product and the user information. Specifically, the associative sentence generation unit 16 inputs the product information of the recommended product and the user information received by the input unit 15 to the learning model 17 that has learned, and obtains an advertising slogan output from the learning model 17 as an advertising slogan for the recommended product. Furthermore, in the case where only product information of a recommended product is received by the input unit 15, the associative sentence generation unit 16 generates, using the learning model 17, an advertising slogan for the recommended product based on the product information of the recommended product.

Next, an example of the configuration of a principal part of an electrical system in the generation device 10 will be explained.

FIG. 3 is a diagram illustrating an example of the configuration of a principal part of an electrical system in the generation device 10. The generation device 10 includes, for example, a computer 20.

The computer 20 includes a central processing unit (CPU) 21, which is an example of a processor that manages each of the functional units of the generation device 10 illustrated in FIG. 1, a read only memory (ROM) 22 that stores a generation program for causing the computer 20 to function as each of the functional units illustrated in FIG. 1, a random access memory (RAM) used as a temporary operation region for the CPU 21, a non-volatile memory 24, and an input/output interface (I/O) 25. The CPU 21, the ROM 22, the RAM 23, the non-volatile memory 24, and the I/O 25 are connected to one another via a bus 26.

The non-volatile memory 24 is an example of a memory unit in which stored information is maintained even when power supplied to the non-volatile memory 24 is interrupted. The non-volatile memory 24 is, for example, a semiconductor memory. However, a hard disk may be used as the non-volatile memory 24. The non-volatile memory 24 is not necessarily built in the computer 20. The non-volatile memory 24 may be, for example, a portable memory unit such as a memory card or a universal serial bus (USB) memory that is removable from the computer 20. The history information storing unit 11 is built in, for example, the non-volatile memory 24.

For example, a communication unit 27, an input unit 28, and an output unit 29 are connected to the I/O 25.

The communication unit 27 is connected to a communication line such as the Internet, which is not illustrated in FIG. 3, and is provided with a communication protocol that performs data communication with an external device connected to the communication line.

The input unit 28 is a unit that receives an instruction and transmits the instruction to the CPU 21. The input unit 28 may be, for example, a button, a touch panel, a keyboard, a mouse, and the like. For a voice instruction, a microphone may be used as the input unit 28.

The output unit 29 is a unit that outputs information processed by the CPU 21. The output unit 29 may be, for example, a liquid crystal display, an organic electro luminescence (EL) display, a projector, a printer a speaker, or the like.

Units connected to the I/O 25 are not limited to the units illustrated in FIG. 3. Other units such as an external memory unit may be connected to the I/O 25 as necessary.

Next, an operation of the generation device 10 will be explained.

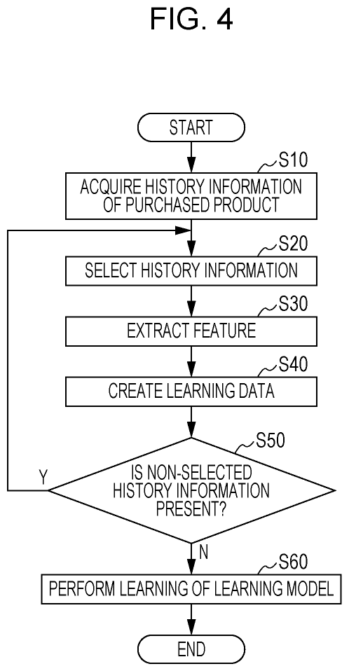

FIG. 4 is a flowchart illustrating an example of the flow of a learning process performed by the CPU 21 of the generation device 10. A generation program that defines the learning process is stored in advance, for example, in the ROM 22 of the generation device 10. The CPU 21 of the generation device 10 reads the generation program stored in the ROM 22 and performs the learning process. The CPU 21 may perform the learning process illustrated in FIG. 4 at any timing, for example, once a month. However, for example, the CPU 21 performs the learning process when receiving a learning instruction for the learning model 17 from a user. Furthermore, the learning process illustrated in FIG. 4 represents a learning process of the learning model 17 for a single user. In the case where user information of a plurality of users is recorded in the history information table 2, the learning process illustrated in FIG. 4 is performed for each of the users.

In step S10, the CPU 21 acquires all the pieces of history information for a case where a specific user purchased a product, that is, history information in which “purchased” is set as a purchase history from the history information table 2 stored in, for example, the non-volatile memory 24.

In step S20, the CPU 21 selects a piece of history information from among the plurality of pieces of history information acquired in step S10.

In step S30, the CPU 21 acquires user information, product information, and an advertising slogan from the history information selected in step S20, and extracts features of the acquired user information, product information, and advertising slogan. Specifically, the CPU 21 extracts the features of the user information, the product information, and the advertising slogan, using a method for compressing content of an item into a predetermined dimension to acquire information configuring the true nature of the item (may be referred to as “intermediate representation”), such as dimensional compression by an embedding layer. The feature of each of the user information, the product information, and the advertising slogan is represented by a real value vector in a predetermined dimension.

In step S40, the CPU 21 creates learning data in which the feature of the user information, the feature of the product information, and the feature of the advertising slogan for the product extracted in step S30. That is, based on the history information selected in step S20, learning data corresponding to the history information is created. Because the history information in which “purchased” is set as a purchase history is acquired in step S10, the purchase history of the user is also associated with the created learning data. Learning data created based on history information indicating that a product was purchased as described above is called “positive example learning data”.

In step S50, the CPU 21 determines whether or not non-selected history information that has not been selected in step S20 is present among the plurality of pieces of history information acquired in step S10. In the case where non-selected history information is present, the process proceeds to step S20, and the CPU 21 selects a piece of history information that has not been selected in step S20. The processing of steps S20 to S50 is repeatedly performed until it is determined in the determination processing in step S50 that there is no non-selected history information. Thus, learning data in which the feature of the user information, the feature of the product information, the feature of the advertising slogan for the product, and the purchase history are associated with one another is created for each of the plurality of pieces of history information acquired in step S10.

In the case where it is determined in step S50 that there is no non-selected history information, the process proceeds to step S60.

In step S60, the CPU 21 causes, using each of the plurality of pieces of created learning data, the learning model 17 to perform machine learning such as deep learning such that in the case where the feature of the user information and the feature of the product information that are associated with learning data are input, the feature of the advertising slogan associated with the same learning data is output. Then, the learning process illustrated in FIG. 4 ends. Accordingly, for example, when a seller who sells a product through an EC website or an advertiser who produces an advertisement that attracts users' interests by entrusted by a seller (hereinafter, collectively referred to as an “operator of the generation device 10”) inputs product information of a recommended product and user information of a user to whom the recommended product is to be recommended, the learning model 17 that generates an advertising slogan for the recommended product may thus be obtained.

Moreover, learning data used for learning of the learning model 17 is learning data created based on an advertising slogan for a product displayed in the case where a user purchased the product. Therefore, an advertising slogan for a recommended product generated by the learning model 17 is generated with reference to an advertising slogan that has actually contributed to purchase of the product. That is, an advertising slogan that attracts more interest of a user than an advertising slogan set by the operator of the generation device 10 without taking into account history information of the user, is generated. Thus, the purchase probability that the user will purchase the recommended product increases.

In step S10 of FIG. 4, only history information in which “purchased” is set as the purchase history is acquired. However, in the case where “searched” is set as the purchase history, it is presumed that a user was interested in a product although the user did not purchase the product. That is, an advertising slogan for the product is considered to be an advertising slogan that attracts an interest of the user. Therefore, the CPU 21 may store, for example, an action that reflects an interest of a user in a product, such as searching for the product or browsing a webpage displaying the product for a predetermined reference time or more, in a purchase history, and may create learning data based on history information including such a purchase history. In this case, weighting representing the degree of interest may be provided for each action that reflects an interest of a user in a product, and the weighting may be reflected in learning of the learning model 17.

For example, a learning parameter of the learning model 17 is adjusted such that learning data including an action reflecting a higher interest of a user in a product affects more on learning of the learning model 17. Specifically, learning data including an action reflecting a higher interest of a user in a product may be used for the learning model 17 more often, and such learning data may be made to exert more influence on the learning model 17 by controlling a learning parameter that controls transmission of information, such as weighting between nodes of the learning model 17.

By adjusting a learning parameter of the learning model 17, the learning accuracy of the learning model 17 may further be improved. For example, a user may purchase a really necessary product without referring to an advertising slogan for the product. In such a case, it is unclear whether the advertising slogan for the product is one attracting an interest of the user. Therefore, it is desirable that the CPU 21 causes learning data created based on history information in which a user is presumed to have purchased a product without refereeing to an advertising slogan for the product to exert as little influence as possible on learning of the learning model 17. Thus, in the case where learning of the learning model 17 is performed using learning data created based on history information in which a product is presumed to have been purchased without reference to an advertising slogan for the product, the CPU 21 may adjust a learning parameter so that the learning data exerts less influence on learning of the learning model 17 than other learning data does. Regarding presumption as to whether or not a user purchased a product without referring to an advertising slogan for the product, for example, the CPU 21 may refer to a browsing time of a webpage on which the product is displayed, the browsing time being recorded as purchase information of the user. In the case where the browsing time is shorter than a set time that is considered to be necessary to read the advertising slogan, the user may be presumed to have purchased the product without referring to the advertising slogan for the product. The set time is set by the operator of the generation device 10.

In contrast, a smaller number of pieces of learning data are created when a smaller number of pieces of history information are used to create learning data from among a plurality of pieces of history information of a user recorded in the history information table 2, and the degree of learning of the learning model 17 tends to be decreased. Thus, in the case where the number of pieces of history information of a user recorded in the history information table 2 is smaller than or equal to a reference number of pieces of history information, the CPU 21 may perform learning of the learning model 17 using learning data created based on history information of another user for whom at least one of the similarity with the user information of the user and the similarity with the tendency of purchase of a product of the user is equal to or more than a predetermined similarity (called “similar history information”) as well.

The similarity of user information may be obtained by, for example, cluster analysis of user attributes such as age, sex, and hobbies or comparing cosine distances of features. Furthermore, the similarity of tendency of purchase of a product may be calculated by, for example, obtaining the number of matched attributes of product information to which attention is paid regarding a purchased product, such as the name of the purchased product or a price range of the purchased product, and comparing cosine distances of features of the attributes. The similarity of tendency of purchase of a product may be determined by comparing product information of products that was not purchased by a user. In this case, tendency of purchase of a user, such as a product that was not purchased by the user, is obtained. The larger the value representing similarity, the higher the similarity of items compared with each other.

Apart from a method for determining similar history information based on at least one of the similarity of user information and the similarity of tendency of purchase of a product, for example, a determination as to whether or not history information is similar history information may be performed using a purchase probability model that has learned association among user information, product information, and purchase or non-purchase of a product, such as outputting a purchase probability of a user for each product. Specifically, the CPU 21 may input user information of a user as a generation target of the learning model 17 and product information recorded in history information of a different user into a purchase probability model. In the case where a purchase probability output from the purchase probability model is equal to or more than a predetermined probability, the user as the generation target of the learning model 17 is considered to show an interest in presentation of a product represented by the product information input to the purchase probability model. Therefore, the history information of the different user including the product information input to the purchase probability model may be determined to be similar history information. The purchase probability model may be established in the generation device 10 or in an external device connected to the generation device 10 via the Internet.

Next, a generation process for generating an advertising slogan for a recommended product using the learning model 17 that has performed learning by the learning process illustrated in FIG. 4 will be explained.

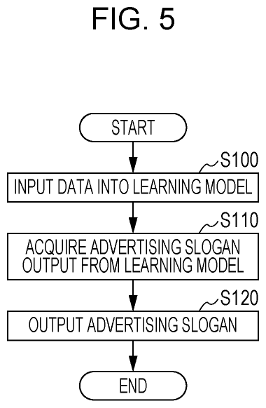

FIG. 5 is a flowchart illustrating an example of the flow of a generation process performed by the CPU 21 of the generation device 10 when product information of a recommended product and user information of a user to whom the recommended product is recommended are received from the operator of the generation device 10. A generation program that defines the generation process is stored in advance, for example, in the ROM 22 of the generation device 10. The CPU 21 of the generation device 10 reads the generation program stored in the ROM 22, and performs the generation process.

In step S100, the CPU 21 extracts features of received product information and user information in the same method as that used in step S30 in FIG. 4. Then, the CPU 21 inputs the feature of the product information and the feature of the user information into the learning model 17.

In step S110, the CPU 21 acquires the feature of an advertising slogan output from the learning model 17 for the feature of the product information and the feature of the user information input in step S100. The CPU 21 converts the acquired feature of the advertising slogan into an advertising slogan expressed in a language and generates an advertising slogan for a recommended product in the same method as that used in step S30 in FIG. 4 in an opposite way.

In step S120, the CPU 21 outputs the advertising slogan generated in step S110 as the advertising slogan for the recommended product to the output unit 29. Then, the generation process illustrated in FIG. 5 ends. The CPU 21 stores an advertising slogan generated for each user into the non-volatile memory 24 in association with a recommended product, so that the generated advertising slogans are able to be referred to.

An example in which user information of a user to whom a recommended product is recommended is received has been explained above. However, user information is not necessarily used.

In the case where only product information of a recommended product is received, the CPU 21 may extract the feature of the product information in step S100, input the extracted feature of the product information into the learning model 17, and acquire an advertising slogan output from the learning model 17. The advertising slogan acquired in this case is not an advertising slogan for the recommended product directed to a specific user but is an advertising slogan popular among a variety of users.

In the learning process illustrated in FIG. 4, in the case where the feature of user information and the feature of product information are input, learning of the learning model 17 is performed such that the feature of an advertising slogan is to be output. Thus, in the generation process illustrated in FIG. 5, the feature of the user information of the user and the feature of the product information of the recommended product are extracted and then input to the learning model 17. Furthermore, information output from the learning model 17 in this case is the feature of the advertising slogan. Thus, the feature of the advertising slogan is converted into an advertising slogan expressed in a language and then output to the output unit 29.

However, for example, by establishing the learning model 17 using an encoder/decoder model including an embedding layer with which a feature is extracted, the feature of user information and the feature of product information are extracted by the encoder, and text corresponding to the features is output by the decoder. Thus, the CPU 21 may input, instead of features, user information and product information into the learning model 17. The information output from the learning model 17 is an advertising slogan expressed in a language. Thus, the CPU 21 does not need to convert the feature of the advertising slogan into an advertising slogan expressed in a language. Furthermore, in this case, learning of the learning model 17 may be performed using learning data in which user information, product information, an advertising slogan for a product, and a purchase history are associated with one another.

Furthermore, to output an advertising slogan, the CPU 21 may refer to the history information table 2 and output a product that is likely to be purchased together with a recommended product, based on history information of a user represented by received user information (hereinafter, referred to as a “specified user”). For example, in the case where history information indicating that a product similar to a recommended product was purchased exists as history information of a specified user, if a purchase history indicating that the same user purchased a different product within a predetermined range including the time when this history information was recorded exists, the CPU 21 identifies the different product as a product that is likely to be purchased together with the recommended product. The CPU 21 may generate, using the learning model 17 that has learned, an advertising slogan for the product that is likely to be purchased together with the recommended product.

Moreover, in the case where an image of a product is recorded in product information in history information, a preference of a user for an image, such as the type of an image viewed by a user who purchased the product, may be presumed. Specifically, an image recommendation model that has performed machine learning of association among a user, an image of a product presented to the user, and purchase or non-purchase of the product is generated. By inputting user information of the specified user and the image of the recommended product into the image recommendation model that has learned, the purchase probability of the user for the input image is obtained.

Therefore, in the case where the operator of the generation device 10 has a plurality of image candidates for a recommended product, the purchase probability of a user is obtained for each of the image candidates. Therefore, the CPU 21 selects an image candidate with the highest purchase probability as an image of the recommended product. The image recommendation model may be established in the generation device 10 or may be established in an external device connected via the Internet.

A preference of a user may change with time, and the user may not purchase a recommended product without showing any interest in an advertising slogan generated by the generation device 10. Therefore, for example, in the case where a situation in which a specific user does not purchase a recommended product occurs a predetermined number of times or more, the CPU 21 may perform the learning process illustrated in FIG. 4 again and perform learning of the learning model 17 again using learning data newly created based on history information of the user. By relearning of the learning model 17, learning based on new learning data that did not used in the previous learning of the learning model 17 is performed. Therefore, an advertising slogan that reflects the latest preference of a user is easily generated.

In contrast, in the case where advertising slogans are generated by the same generation device 10 for the same user, an advertising slogan similar to a previously generated advertising slogan is generated more easily as the number of advertising slogans generated increases. Thus, representation content (referred to as “taste”) expressing a recommended product from a new point of view tends to be obtained with difficulty.

When such a tendency occurs, the learning model 17 easily generates a new advertising slogan similar to any one of the advertising slogans generated previously. Therefore, in the case where an instruction to generate an advertising slogan for a recommended product is received from the operator of the generation device 10 after the number of similar advertising slogans generated for the same user has reached a predetermined number or more, the CPU 21 selects, without using the learning model 17, an advertising slogan for the recommended product from among advertising slogans for products similar to the recommended product that were generated previously for the specified user and outputs the selected advertising slogan. By performing this operation, even if processing for generating a new advertising slogan using the learning model 17 is omitted, an advertising slogan in which the specified user is interested may be obtained.

Furthermore, the load of the generation device 10 is reduced compared to a case where every advertising slogan is generated using the learning model 17. Therefore, for example, in the case where the load of the generation device 10 has increased to a predetermined load value or more, an advertising slogan for a recommended product may be selected from among advertising slogans generated previously for a specified user and output.

As explained above, the degree of learning of the learning model 17 tends to decrease due to shortage of learning data. Thus, in the case where an advertising slogan for a recommended product is generated for a user for whom the number of pieces of history information that have been used to create learning data among the plurality of piece of history information recorded in the history information table 2 is smaller than or equal to a reference number of pieces of history information, an advertising slogan in which the user is less likely to show an interest may be generated.

In the case where user information of such a user is received along with product information of a recommended product, the CPU 21 may replace the user information of the specified user with user information of a different user for whom history information is similar to history information of the specified user and the number of pieces of history information that have been used to create learning data exceeds the reference number of pieces of history information and then generate an advertising slogan for the recommended product. In such a case, the advertising slogan for the recommended product generated using the user information of the different user is obtained. However, because the history information of the specified user and the history information of the different user are similar to each other, even if the advertising slogan for the recommended product generated as described above is output as the advertising slogan for the recommended product for the specified user, an advertising slogan in which the specified user is interested may be obtained.

The similarity of history information is represented by the total sum of the similarities of user information, product information of purchased products, tendencies of purchase of products of users. The CPU 21 may determine that the two pieces of history information are similar to each other when the total sum is equal to or more than a threshold.

In the example provided above, before the generation device 10 generates an advertising slogan for a recommended product, it is determined whether or not the number of pieces of history information of a specified user that have been used to create learning data is smaller than or equal to the reference number of pieces of history information. However, in the case where the number of pieces of history information of a specified user that have been used to create learning data is smaller than or equal to the reference number of pieces of history information, the degree of learning of the learning model 17 for the specified user is considered to be lower than that of other users. Thus, an advertising slogan generated using the learning model 17 for the specified user is not necessarily represented in a grammatically correct expression. Therefore, the CPU 21 may input the advertising slogan generated by the learning model 17 into an evaluation model that evaluates whether representation of the advertising slogan is grammatically correct. In the case where the representation of the advertising slogan is evaluated not to be correct, the user information of the specified user may be replaced with user information of a different user having similar history information, and an advertising slogan for the recommended product for the specified user may thus be generated.

Moreover, to generate an advertising slogan for a recommended product for a specified user, the generation device 10 may determine a character form of the advertising slogan according to a preference of the user. The character form of an advertising slogan represents the appearance of the advertising slogan and includes the color of a character of the advertising slogan, the type of a font used for the advertising slogan, and the size of a character of the advertising slogan.

In the case where the learning model 17 is provided with an attention mechanism, the learning model 17 is able to express, for each of words included in an advertising slogan, the degree of influence of the word exerted on generation of the advertising slogan as a numerical value, in the process of generation of the advertising slogan. A word with a higher degree of influence is considered to be a word that is more likely to earn user's interest, that is, a word that more reflects a user's preference. Thus, the CPU 21 may set the character form of a word whose degree of influence is equal to or higher than a predetermined reference degree of influence to a character form different from those of different words. In this case, an advertising slogan that is more likely to earn user's interest is generated compared to a case where the character form of an advertising slogan is fixed to a predetermined character form. Therefore, an increase in the sales of a recommended product may be achieved.

The CPU 21 refers to history information regarding a recommended product provided with an advertising slogan with a changed character form, and monitors whether or not the recommended product was purchased. Then, the CPU 21 may correct the degree of influence of a word in accordance with purchase or non-purchase of the recommended product.

Furthermore, the CPU 21 may set the character form of a randomly selected word to a character form different from other words, without depending on user's preference. In this case, words whose part of speech are noun, verb, adjective, and adverb are able to transmit meaning to a user more clearly than words whose part of speech are postpositional particle, auxiliary verb, or the like. Therefore, the CPU 21 may randomly select words whose character form is changed based on the part of speech of a word. A part of speech of a word is obtained by, for example, morphological analysis of an advertising slogan.

Furthermore, although the operator of the generation device 10 may generate an advertising slogan for a recommended product for a specific user. However, an advertising slogan for a recommended product for a user group with similar characteristics, such as male users in their fifties or users whose hobby is travelling. For example, to generate an advertising slogan for a recommended product directed to a user group of males in their fifties, the operator of the generation device 10 inputs characteristics of the target user group, such as “age=fifties” and “sex=male”, to the generation device 10.

The CPU 21 of the generation device 10 establishes in advance other learning models corresponding to characteristics of assumed various user groups as well as a learning model for a specific user. The CPU 21 inputs product information of a recommended product, and generates an advertising slogan for a user group of males in their fifties, based on a different learning model for generating an advertising slogan popular among the user group of males in their fifties. Characteristics of a user group for which the learning model 17 is established in advance are designated by, for example, an administrator who administrates the generation device 10.

As described above, the generation device 10 according to the first exemplary embodiment receives user information of a specified user and product information of a recommended product recommended to the specified user. Then, the generation device 10 inputs the received user information and product information of the recommended product into the learning model 17 that has learned association among the user information, the product information of the product presented to the user, and an advertising slogan in which the user represented by the user information shows an interest, using learning data created from history information, and thus generates an advertising slogan for the recommended product based on a purchase history of the user.

### Second Exemplary Embodiment

In the first exemplary embodiment, an advertising slogan for a recommended product in which a user shows an interest is generated using the learning model 17 that outputs an advertising slogan based on user information and product information of a recommended product.

In a second exemplary embodiment, a generation device 10A that outputs, using a learning model 18 that outputs the degree of interest shown by a user (may be referred to as a “score”) for each of a plurality of advertising slogan candidates prepared in advance, an advertising slogan for a recommended product from among the plurality of advertising slogan candidates by referring to the score, will be explained.

An example of the functional configuration of the generation device 10A according to the second exemplary embodiment is the same as the example of the functional configuration of the generation device 10 according to the first exemplary embodiment illustrated in FIG. 1 with an exception that the learning model 17 is replaced with the learning model 18. The input unit 15 of the generation device 10 according to the first exemplary embodiment optionally receives user information of a user to whom a recommended product is recommended. However, the input unit 15 of the generation device 10A according to the second embodiment receives user information of a user to whom a recommended product is recommended. The input unit 15 of the generation device 10A receives product information of a recommended product, user information of a user to whom the recommended product is recommended, and an advertising slogan candidate for the recommended product.

Furthermore, an example of the configuration of a principal part of an electrical system in the generation device 10A includes the computer 20, as illustrated in FIG. 3.

Next, an operation of the generation device 10A will be explained.

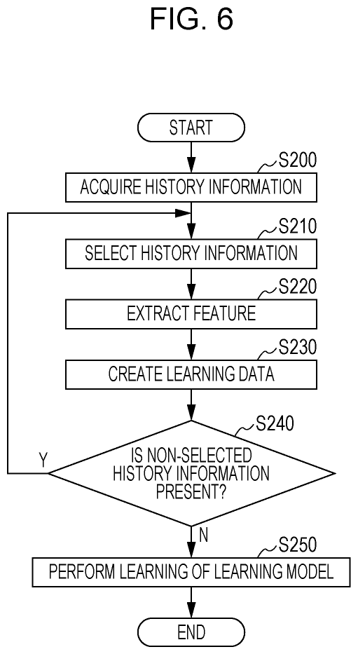

FIG. 6 is a flowchart illustrating an example of the flow of a learning process performed by the CPU 21 of the generation device 10A. A generation program that defines the learning process is stored in advance, for example, in the ROM 22 of the generation device 10A. The CPU 21 of the generation device 10A reads the generation program stored in the ROM 22 and performs the learning process. The CPU 21 may perform the learning process illustrated in FIG. 6 at any timing, for example, once a month. However, for example, the CPU 21 performs the learning process when receiving a learning instruction for the learning model 18 from a user. Furthermore, the learning process illustrated in FIG. 6 represents a learning process of the learning model 18 for a single user. In the case where user information of a plurality of users is recorded in the history information table 2, the learning process illustrated in FIG. 6 is performed for each of the users.

In step S200, the CPU 21 acquires history information of a specific user, regardless of whether or not the specific user purchased a product, from the history information table 2 stored in, for example, the non-volatile memory 24.

In step S210, the CPU 21 selects a piece of history information from among the plurality of pieces of history information acquired in step S200.

In step S220, as in the processing of step S30 illustrated in FIG. 4, the CPU 21 acquires user information, product information, and an advertising slogan from the history information selected in step S210, extracts features of the acquired user information, product information, and advertising slogan, and extracts information regarding purchase or non-purchase of a product, that is, a purchase history of the user. For extraction of the feature of the advertising slogan, the CPU 21 may divide the advertising slogan into words and extract the feature of each of the words. For example, the feature of each word is extracted.

In step S230, the CPU 21 creates learning data in which the feature of the user information, the feature of the product information, the feature of the advertising slogan for the product, and the purchase history extracted in step S220 are associated with one another. The purchase history associated with the learning data is represented by a numerical value. For example, a purchase history “purchased” that is represented by “1” and a purchase history “not purchased” that is represented by “0” are associated with the learning data. In the case where details indicating that a user showed an interest in a product although the user did not purchase the product are set in a purchase history, the higher the degree of interest of a user, the closer to “1” the value of the purchase history. For example, in the case where a purchase history indicates “searched”, “0.5” is set for the purchase history. Furthermore, it is considered that the browsing time of a webpage on which a product is displayed is proportional to the interest of a user. Therefore, a value closer to “1” is set for a purchase history as the browsing time of a webpage on which the product is displayed becomes longer. A value set for a purchase history represents a purchase probability indicating the probability that a user will purchase a product. In the example provided above, “1” indicates that a user will purchase a product with a probability of 100%, whereas “0” indicates a purchase probability of 0%.

In the history information table 2, a purchase history “not purchased” represents that a product was not purchased by a user although a webpage or the like on which product information is displayed was browsed by the user. Thus, the purchase history “not-purchased” indicates that the user did not like the product.

That is, learning data in the second exemplary embodiment includes learning data created based on history information for a case where a user did not purchase a product although browsed product information, as well as learning data created based on history information for a case where the user showed an interest in a product and learning data created based on history information for a case where the user purchased a product. As described above, acquiring history information for a case where a user did not purchase a product from the history information table 2 is called “negative sampling”. Learning data created based on history information acquired by negative sampling is called “negative example learning data”.

Furthermore, a purchase probability represents a numerical value indicating a purchase history of a product and represents the degree of interest of a user in an advertising slogan. Therefore, a purchase probability is an example of a score in the second exemplary embodiment. Hereinafter, an example in which the purchase probability of a product is used as a score will be explained. However, any numerical value may be used as a score as long as it represents the degree of interest of a user in an advertising slogan. For example, the degree of favorability of a product may be converted into a numerical value and used as a score.

In step S240, the CPU 21 determines whether or not non-selected history information that has not been selected in step S210 is present among the plurality of pieces of history information acquired in step S200. In the case where non-selected history information is present, the process proceeds to step S210, and the CPU 21 selects a piece of history information that has not been selected in step S210. The processing of steps S210 to S240 is repeatedly performed until it is determined in the determination processing in step S240 that there is no non-selected history information. Thus, learning data in which the feature of the user information, the feature of the product information, the feature of the advertising slogan for the product, and the purchase history are associated with one another is created for each of the plurality of pieces of history information acquired in step S200.

In contrast, in the case where it is determined in the determination processing in step S240 that there is no no-selected history information, the process proceeds to step S250.

In step S250, the CPU 21 performs, using each of the plurality of pieces of created learning data, learning of the learning model 18 such that in the case where the feature of the user information, the feature of the product information, and the feature of the advertising slogan that are associated with learning data are input, the purchase history associated with the same learning data, that is, the purchase probability, is output. Then, the learning process illustrated in FIG. 6 ends.

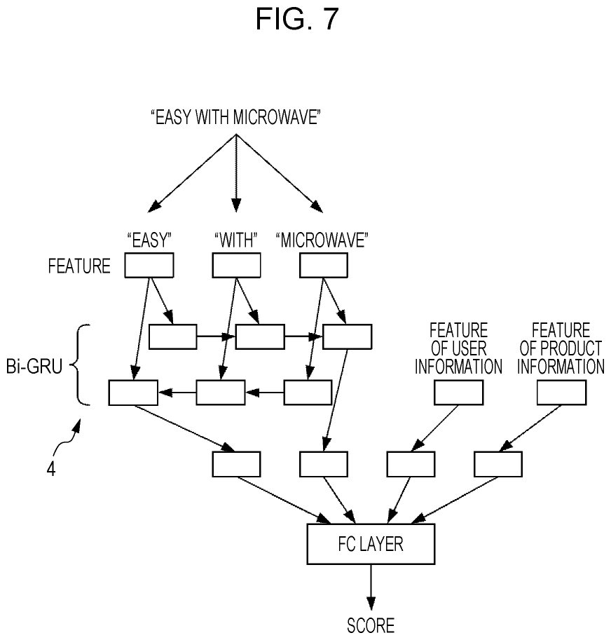

FIG. 7 is a diagram illustrating a learning example in the learning model 18. In the example illustrated in FIG. 7, the CPU 21 divides an advertising slogan “Easy with microwave” into words, and inputs each of the words into bi-directional gated recurrent unit (Bi-GRU) 4. Thus, the CPU 21 extracts the feature of the advertising slogan, and creates learning data in which the feature of user information, the feature of product information, the feature of the advertising slogan for the product, and purchase probability are associated with one another. Then, the CPU 21 inputs the feature of the user information, the feature of the product information, and the feature of the advertising slogan for the product into a fully connected (FC) layer of the learning model 18, and performs learning of the learning model 18 such that a score output from the learning model 18 is close to the purchase probability associated with the learning data. The Bi-GRU 4 is an example of an embedding layer.

The CPU 21 may input user information, product information, and an advertising slogan, instead of features, to the learning model 18. In this case, the CPU 21 may perform learning of the learning model 18 using learning data in which user information, product information, an advertising slogan for a product, and a purchase probability are associated with one another.

As explained above in the first exemplary embodiment, in the learning model 18, it is desirable that learning data created based on history information for a case where a user purchased a product without referring to an advertising slogan for the product exerts as little influence as possible on learning of the learning model 18. Thus, to perform learning of the learning model 18 using learning data created based on history information for a case where a product was purchased without an advertising slogan for the product being referred to, the CPU 21 may adjust a learning parameter such that the degree of influence of the learning data on learning of the learning model 18 is smaller than the degree of influence of other learning data on learning of the learning model 18.

Next, a generation process for generating an advertising slogan for a recommended product using the learning model 18 that has learned by the learning process illustrated in FIG. 6 will be explained.

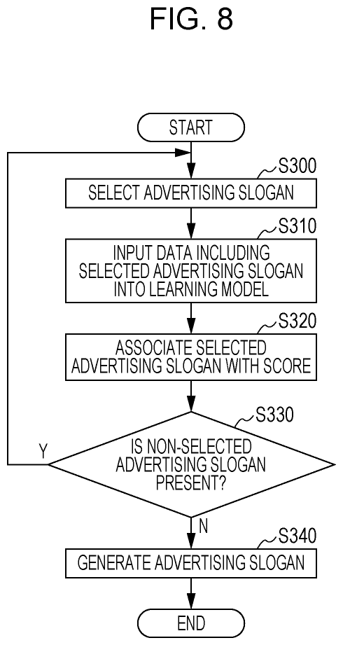

FIG. 8 is a flowchart illustrating an example of the flow of a generation process performed by the CPU 21 of the generation device 10A in the case where product information of a recommended product, user information of a user to whom the recommended product is recommended, and a plurality of advertising slogan candidates for the recommended product are received from an operator of the generation device 10A. A generation program that defines the generation process is stored in advance, for example, in the ROM 22 of the generation device 10A. The CPU 21 of the generation device 10A reads the generation program stored in the ROM 22 and performs the generation process.

In step S300, the CPU 21 selects an advertising slogan from among the received plurality of advertising slogan candidates. Hereinafter, each advertising slogan selected from a plurality of advertising slogan candidates will be called a “selected advertising slogan”.

In step S310, the CPU 21 extracts features of the received product information and user information and the selected advertising slogan. Then, the CPU 21 inputs a combination of the feature of the product information, the feature of the user information, and the feature of the selected advertising slogan into the learning model 18.

The learning model 18 that has received the feature of the product information, the feature of the user information, and the feature of the selected advertising slogan outputs, as a score, a purchase probability indicating the probability that a specified user will purchase a recommended product in the case where the selected advertising slogan is added to the recommended product. Thus, in step S320, the CPU 21 stores the selected advertising slogan and the score output from the learning model 18 in association with each other into the non-volatile memory 24.

In step S330, the CPU 21 determines whether or not a non-selected advertising slogan candidate that has not been selected in step S300 is present among the received advertising slogan candidates. In the case where a non-selected advertising slogan candidate is present, the process proceeds to step S300, and the CPU 21 selects an advertising slogan candidate that has not been selected in step S300.

The processing of steps S300 to S330 is repeatedly performed until it is determined in the determination processing in step S330 that there is no non-selected advertising slogan candidate. Accordingly, a score output from the learning model 18 is associated with each of the received advertising slogan candidates.

In contrast, in the case where it is determined in the determination processing in step S330 that there is no non-selected advertising slogan candidate, the process proceeds to step S340.

In step S340, the CPU 21 outputs an advertising slogan candidate with which the highest score is associated from among the plurality of advertising slogan candidates with which respective scores are associated, as the advertising slogan for the recommended product, to the output unit 29.

For example, the operator of the generation device 10A generates an advertising slogan candidate for a recommended product, using an advertising slogan generation device that includes a generation model that has learned machine learning such that in the case where an explanatory sentence for a recommended product is input, an advertising slogan candidate for the recommended product is output. However, the operator of the generation device 10A may use not only an advertising slogan candidate generated by the advertising slogan generation device but also, for example, an advertising slogan for a product similar to the recommended product as an advertising slogan candidate for the recommended product.

An explanatory sentence of a recommended product represents a sentence created to clearly explaining the details of the recommended product to others. An explanatory sentence is not composed of a list of words. An explanatory sentence is expressed as text representing a coherent meaning, for example, by connecting a noun, a verb, an adjective, an adverb, and the like by a postpositional particle so that modification relation of the parts of speech may be clarified.

In the case where the received feature of a recommended product and the received advertising slogan candidate are stored in association with each other in the non-volatile memory 24, the CPU 21 may acquire an advertising slogan for a product similar to the received feature of the recommended product from the non-volatile memory 24 and add it to the advertising slogan candidate received from the operator of the generation device 10A. Because the number of advertising slogan candidates for the recommended product increases, an advertising slogan in which a specified user shows an interest may be easily obtained, compared to a case where an advertising slogan for a recommended product is selected from among advertising slogan candidates for the recommended product received from the operator of the generation device 10A.

Moreover, the CPU 21 may select an advertising slogan for a recommended product from among advertising slogan candidates for a product similar to the received feature of the recommended product. In this case, the operator of the generation device 10A does not need to prepare an advertising slogan candidate for the recommended product and does not need to input the advertising slogan candidate to the generation device 10A.

In the case where an advertising slogan generation device is used to generate an advertising slogan candidate for a recommended product, a generation model of the advertising slogan generation device is required to generate an advertising slogan that earns as much user's interest as possible from an explanatory sentence for a recommended product. Therefore, the CPU 21 performs learning of a generation model such that an advertising slogan obtained by inputting an explanatory sentence for a product represented by product information included in learning data into the generation model is close to an advertising slogan included in the same learning data. Then, the CPU 21 inputs learning data in which an advertising slogan included in learning data is replaced with an advertising slogan generated by the generation model into the learning model 18, and loss representing an error between a score output from the learning model 18 and the maximum score (“1” in the second exemplary embodiment) is backward propagated by the generation model such that the loss becomes small.

Accordingly, compared to a case where learning of a generation model is performed without a score for a generated advertising slogan being taking into account, an advertising slogan in which a user easily shows an interest may be generated. A generation model that is provided in an advertising slogan generation device may be provided in the generation device 10A. In this case, there is no need to provide an advertising slogan generation device.

Learning of the learning model 18 and a generation model may be performed in any order. After learning of one model is completed, learning of the other model may start. Alternatively, learning of the learning model 18 and the generation model may be performed alternately.

Furthermore, for example, in the case where an advertising slogan is displayed along with a recommended product on a webpage of an EC website or in the case where an advertising slogan is displayed on a label attached to a recommended product, a certain constraint may be provided for displaying the advertising slogan.

For example, because a region on a webpage allocated for introduction of a recommended product is limited or the size of a label is limited, there is an upper limit in the number of characters of an advertising slogan that are able to be displayed on a medium on which the advertising slogan is displayed, such as a region on a webpage or a label. Therefore, it is desirable that the operator of the generation device 10A inputs in advance the maximum number of characters that are able to be displayed on a medium into the generation device 10A and the CPU 21 outputs, as an advertising slogan for a recommended product, an advertising slogan candidate whose number of characters is smaller than or equal to the maximum number of characters and whose score is the highest among the received plurality of advertising slogan candidates.

The maximum number of characters that are able to be displayed on a medium varies according to the size of characters. Therefore, the operator of the generation device 10A may input information indicating the size of a region in which an advertising slogan is to be displayed, for example, information indicating an area of the region or the longitudinal and transverse lengths of the region if the region is rectangular, to the generation device 10A. The CPU 21 autonomously sets the maximum number of characters that are able to be displayed on a medium, based on information indicating the size of a region in which an advertising slogan is to be displayed and the size of characters to be used for the advertising slogan.

Furthermore, in the case where text such as an advertising slogan for a recommended product (called “existing text”) has already been displayed on a medium, an advertising slogan with a taste different from that of the existing text easily earns user's interest because text of a variety of representation contents may be displayed for the recommended product. Thus, the CPU 21 receives existing text from the operator of the generation device 10A and calculates the similarity between the existing text and each of a plurality of advertising slogan candidates. Then, the CPU 21 may extract an advertising slogan candidate whose similarity with the existing text is lower than a reference similarity from among the plurality of advertising slogan candidates and output an advertising slogan with the highest score from among the extracted advertising slogan candidates as the advertising slogan for the recommended product.

As described above, as a case where an advertising slogan having a low similarity with other text is preferably generated, for example, a case where different recommended products are displayed on a webpage and the generation device 10A generates advertising slogans for the recommended products is considered. In the case where advertising slogans for all the recommended products emphasize low prices, such as “Confident in our low prices!” or “Lowest price!”, even if each of the advertising slogans attracts an interest of a user, such advertising slogans do not much appeal to the user because arrangement of advertising slogans with the similar tastes degrades the variety of advertising slogans.

Thus, to generate advertising slogans for a plurality of recommended products to be displayed on the same webpage, the operator of the generation device 10A inputs the same product group identification information provided to the recommended products to be displayed on the same medium to the generation device 10A.

When receiving product group identification information, the CPU 21 obtains the similarity between advertising slogans with the highest scores output from the learning model 18 for recommended products provided with the same product group identification information and determines whether or not the similarity with each of the advertising slogans for all the recommended products is lower than or equal to a reference similarity.

In the case where the similarity of an advertising slogan exceeds the reference similarity, the CPU 21 sequentially selects an advertising slogan having the next highest score until an advertising slogan having a similarity lower than or equal to the reference similarity is obtained, and repeatedly performs the determination as to whether or not the similarity of an advertising slogan is lower than or equal to the reference similarity.

Accordingly, an advertising slogan whose similarity with each of the recommended products provided with the same product group identification information is provided is lower than or equal to the reference similarity is generated. Thus, the variety of advertising slogans may be ensured. The reference similarity is set to the generation device 10A by the operator of the generation device 10A. Furthermore, as the reference similarity, at least one of a similarity based on the similarity of a word used in an advertising slogan and a similarity based on a taste of an advertising slogan is set.

In contrast, some users may prefer sense of unity in which similar advertising slogans are displayed for recommended products that are displayed on the same webpage. In such a case, the CPU 21 may select the advertising slogan with the highest score from among advertising slogans for recommended products provided with the same product group identification information that have a similarity exceeding the reference similarity and use the selected advertising slogan as the advertising slogan for the recommended product.

The operator of the generation device 10A designates whether an advertising slogan with a similarity lower than or equal to the reference similarity is used as the advertising slogan for the recommended product or an advertising slogan with a similarity higher than the reference similarity is used as the advertising slogan for the recommended product.

Furthermore, text that constraints the taste of an advertising slogan (referred to as an “entry 6”), such as “Featuring easy cooking”, is displayed as existing text on a medium, the CPU 21 needs to generate an advertising slogan that suits the taste of the entry 6. Therefore, the CPU 21 may receive the entry 6 from the operator of the generation device 10A, divide the entry 6 and a plurality of advertising slogan candidates into clusters (may be referred to as “categories”) by, for example, cluster analysis, and output an advertising slogan candidate associated with the highest score among advertising slogan candidates included in the same cluster as the cluster into which the entry 6 is categorized, as an advertising slogan for a recommended product, to the output unit 29. There is no restriction in expression of the entry 6. The entry 6 may be an explanatory sentence, an advertising slogan, or a word.

As a modification in which an advertising slogan for a recommended product is generated in consideration of existing text, for example, existing text is recorded with an advertising slogan recorded in history information. The CPU 21 creates learning data in which the feature of user information, the feature of product information, the feature of an advertising slogan for a product, the feature of the existing text, and a purchase history are associated with one another, and performs learning of a learning model 18A. Then, the CPU 21 may receive product information of a recommended product, user information of a user to whom the recommended product is recommended, an advertising slogan candidate, and existing text displayed for the recommended product from the operator of the generation device 10A, input features of the product information, the user information, the advertising slogan candidate, and the existing text into the learning model 18A that has learned, and output an advertising slogan with the highest score as the advertising slogan for the recommended product.

n the learning model 18A, learning of association regarding what kind of advertising slogan achieves high purchase probability for existing text is performed. Thus, by displaying existing text along with an advertising slogan, an advertising slogan that achieves synergistic effect that further attracts an interest of a specified user is generated, compared with a case where only an advertising slogan is displayed.

The CPU 21 may generate an advertising slogan for a recommended product such that a constraint regarding display on a medium may be satisfied. However, as explained above in the first exemplary embodiment, an advertising slogan for a recommended product may be generated such that a constraint regarding a preference of a user may be satisfied.

Specifically, for example, the CPU 21 records the character form of an advertising slogan as an advertising slogan recorded in history information. The CPU 21 creates learning data in which the feature of user information, the feature of product information, the feature of an advertising slogan for a product, the character form of the advertising slogan, and a purchase history are associated with one another, and performs learning of a learning model 18B such that the character form of the advertising slogan and the purchase probability are output with respect to the feature of the user information, the feature of the product information, and the feature of the advertising slogan for the product. Then, the CPU 21 receives product information of a recommended product, user information of a user to whom the recommended product is recommended, and an advertising slogan candidate from the operator of the generation device 10A. The CPU 21 inputs the features of the product information, the user information, and the advertising slogan candidate into the learning model 18B that has learned, and the learning model 18B outputs a score and a character form suitable for the advertising slogan. The CPU 21 expresses the advertising slogan with the highest score in the character form output along with the score of the advertising slogan from the learning model 18, and outputs the advertising slogan as the advertising slogan for the recommended product.

The learning model 18B has learned association between an advertising slogan in which a user shows an interest and a character form used for the advertising slogan. Therefore, compared to the case where an advertising slogan is generated in a predetermined character form, an advertising slogan that earns more interest of a specified user may be generated.

Preferences of a user may include not only the character form of an advertising slogan but also the length of an advertising slogan. For example, some users may be likely to be interested in an advertising slogan of a shorter sentence composed of, for example, ten characters or less, than an advertising slogan of a longer sentence.

Thus, the CPU 21 refers to history information of a user, and estimates the number of characters of an advertising slogan whose purchase probability is equal to or higher than a predetermined probability, based on the relationship of the purchase probability of a product set according to purchase history included in the history information and the number of characters of an advertising slogan for the product. Then, the CPU 21 may select, from among the received advertising slogan candidates, the advertising slogan whose number of characters is close to the number of characters estimated as the number of characters for which purchase probability is equal to or higher than the predetermined probability and whose score is the highest and output the selected advertising slogan as the advertising slogan for the recommended product. There is no constraint in a method for estimating the relevance between the purchase probability and the number of characters of an advertising slogan. A known estimation method may be used.

For example, to perform learning of the learning model 18, the CPU 21 may also input the number of characters of an advertising slogan for a product to the learning model 18 and causes the learning model 18 to learn the association between the purchase probability of the product set based on purchase history and the number of characters of the advertising slogan for the product. In this case, the learning model 18 outputs a score taking into consideration the number of characters of an advertising slogan candidate for the recommended product. Thus, there arises a tendency in which an advertising slogan with the highest score among advertising slogan candidates is an advertising slogan having the number of characters close to the number of characters desired by a specified user.

An example of the generation device 10A that outputs an advertising slogan for a recommended product suitable for a specified user, based on a score, from among advertising slogan candidates received from the operator of the generation device 10A has been explained. However, the generation device 10A does not necessarily output a single advertising slogan for a recommended product. The generation device 10A may output a plurality of advertising slogans. For example, the CPU 21 may select and output a plurality of advertising slogans from among received advertising slogan candidates, and the operator of the generation device 10A may be allowed to select an advertising slogan for a recommended product from among the output advertising slogans.

Specifically, the CPU 21 rearranges and outputs received advertising slogan candidates in descending order of score or outputs a predetermined number of advertising slogans among the received advertising slogan candidates from the highest scores, and the operator of the generation device 10A is allowed to select an advertising slogan for the recommended product.

In this case, if the generation device 10A outputs advertising slogans with the same taste, selection of any advertising slogan brings no big change, and there is not much meaning in selection of an advertising slogan by the operator of the generation device 10A. Furthermore, if there is a change in the preference of a user or an event that changes the state of mind of the user, such as a payday, happens, the user may exhibit a tendency of purchase of a product different than before. Thus, an advertising slogan with a high score might not be an advertising slogan suitable for the user.

Accordingly, the CPU 21 may include an advertising slogan with a different taste whose similarity with another advertising slogan is lower than or equal to the reference similarity or an advertising slogan with a low score in advertising slogans to be output to the operator of the generation device 10A.

Thus, a plurality of advertising slogans with different tastes need to be prepared as advertising slogan candidates for a recommended product. However, it is difficult for the operator of the generation device 10A to create such advertising slogans.

Therefore, for example, the CPU 21 refers to a database in which product information and advertising slogans for products displayed on webpages of various EC websites or advertising leaflets for newspaper or the like are stored, performs cluster analysis of the advertising slogans based on tastes, and generates, for each cluster, a cluster model that has performed machine learning of association between a product and an advertising slogan. That is, when product information of a product is input into each of the cluster models, an advertising slogan with a taste corresponding to the cluster is output. For example, an advertising slogan with a taste emphasizing prices is output from a cluster model that has learned based on advertising slogans of a cluster having a taste with emphasis on prices, and an advertising slogan with a taste emphasizing quality is output from a cluster model that has learned based on advertising slogans of a cluster having a taste with emphasis on quality.

For example, the CPU 21 inputs product information of a recommended product to each of a plurality of cluster models that generate advertising slogans with different tastes, and generates advertising slogan candidates with different tastes for the same recommended product. Then, the CPU 21 inputs the features of advertising slogan candidates with different tastes along with features of user information of a specified user and product information of the recommended product into the learning model 18, and a score is associated with each of the input advertising slogans. Thus, advertising slogans with different tastes are output from the generation device 10A.

The CPU 21 stores an advertising slogan for a recommended product selected by the operator of the generation device 10A. In the case where the similarity between the advertising slogan selected by the operator of the generation device 10A and an advertising slogan previously selected by the operator of the generation device 10A is lower than or equal to the reference similarity, it is presumed that there starts to be a change in an advertising slogan required by the operator of the generation device 10A. In this case, learning of the learning model 18 may be performed again.

Specifically, the CPU 21 collects from the history information table 2 all the pieces of history information including history information newly added after learning of the learning model 18 to create learning data, and causes the learning model 18 to learn from the beginning. Accordingly, the learning model 18 may be made to reflect a change in preference of the operator for an advertising slogan that has occurred after learning of the learning model 18.

However, a method for relearning of the learning model 18 is not limited to the example mentioned above. For example, the CPU 21 may collect only history information recorded after a predetermined point in time (for example, three months before the current point in time) from the history information table 2 to create learning data and cause the learning model 18 to learn again from the beginning only using the created learning data. Furthermore, the CPU 21 may collect only history information newly added after learning of the learning model 18 to create learning data and cause the learning model 18 to learn again from the beginning only using the created learning data. Furthermore, the CPU 21 may cause the current learning model 18 to perform additional learning using learning data created from only history information within a specific period, instead of creating the learning model 18 again from the beginning. A method for relearning of the learning model 18 is instructed by the operator.

By performing a learning process again, the tendency of purchase of a product by a user based on history information collected after a learning process is reflected in the learning model 18. Thus, the generation device 10A is able to output an advertising slogan that attracts more interest of the user may be output, compared to before the relearning.

The CPU 21 refers to history information of a user for a product provided with a generated advertising slogan. In the case where the probability that the user will purchase a product is decreased compared to before, it is also be presumed that there starts to be a change in an advertising slogan in which a user shows an interest. In this case, the CPU 21 may also perform a learning process again for the user.

Furthermore, the modification of the first exemplary embodiment also includes application to the generation device 10A. For example, the generation device 10A may generate an advertising slogan for a product that is likely to be purchased together with a recommended product or select an image with the highest purchase probability as an image of the recommended product. Furthermore, the generation device 10A may generate an advertising slogan for a recommended product by replacing user information of a specified user with user information of a different user whose history information is similar to that of the user information of the specified user. Furthermore, the generation device 10A may generate an advertising slogan for a recommended product such that at least one of a constraint regarding a preference of a user and a constraint regarding display on a medium is satisfied or may generate an advertising slogan for a recommended product for user group with similar characteristics.

As described above, with the generation device 10A according to the second exemplary embodiment, an advertising slogan for a recommended product is generated based on a score obtained by inputting an advertising slogan candidate into the learning model 18.

### Application of Second Exemplary Embodiment

An example of the generation device 10A that generates an advertising slogan for a recommended product has been explained above. The generation device 10A may edit a medium to attract user's interest, based on generated advertising slogans for various recommended products. In this example, advertising slogans that suit the taste of the entry 6 displayed on a medium and editing of a webpage in which a list of recommended products is displayed will be explained.

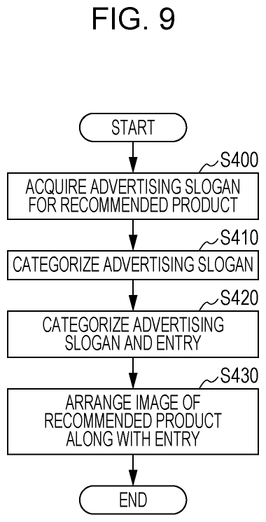

FIG. 9 is a flowchart illustrating an example of the flow of an editing process performed by the CPU 21 of the generation device 10A when receiving an instruction to start editing from the operator of the generation device 10A. A generation program that defines an editing process is stored in advance, for example, in the ROM 22 of the generation device 10A. The CPU 21 of the generation device 10A reads the generation program stored in eh ROM 22 and performs the editing process. The CPU 21 stores an advertising slogan added to a recommended product for each user along with an image of the recommended product in the non-volatile memory 24.

When receiving an instruction to start editing from the operator of the generation device 10A, the CPU 21 acquires an advertising slogan for each recommended product for a specified user from the non-volatile memory 24 in step S400.

In step S410, the CPU 21 performs cluster analysis of tastes of the advertising slogans acquired in step S400, and identify a cluster including the largest number of categorized items.

In step S420, the CPU 21 further performs cluster analysis of the advertising slogans categorized into the cluster including the largest number of categorized items and the entry 6.

In step S430, the CPU 21 acquires images of recommended products corresponding to the advertising slogans included in the same cluster as the cluster into which the entry 6 is categorized from the non-volatile memory 24, and arranges the images of the recommended products along with the entry 6 in the webpage. Then, the editing process illustrated in FIG. 9 ends.

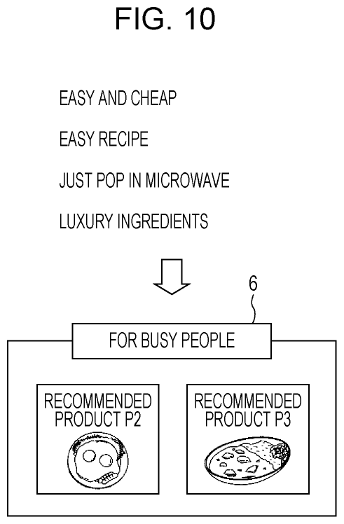

FIG. 10 is a diagram illustrating an example of recommended products displayed in a webpage, which is an example of a medium, in the case where the editing process illustrated in FIG. 9 is performed.

For example, advertising slogans “Easy and cheap”, “Easy recipe”, “Just pop in microwave”, and “Luxury ingredients” are added to a recommended product P1, a recommended product P2, a recommended product P3, and a recommended product P4, respectively. The recommended product P1 is banana, the recommended product P2 is an egg dish, the recommended product P3 is curry with rice, and the recommended product P4 is sukiyaki.

The advertising slogan “Luxury ingredients” has a different taste from the other advertising slogans that highlight easiness. Thus, a cluster including “Easy and cheap”, “Easy recipe”, and “Just pop in microwave” is identified as the cluster having the largest number of categorized items.

For example, if the entry 6 is set to “For busy people”, cluster analysis for elements “For busy people”, “Easy and cheap”, “Easy recipe”, and “Just pop in microwave” is performed.

The entry 6 “For busy people” emphasizes time-saving, and the advertising slogans “Easy recipe” and “Just pop in microwave” also highlight time-saving. Therefore, “For busy people”, “Easy recipe”, and “Just pop in microwave” are categorized into the same cluster.

Meanwhile, the advertising slogan “Easy and cheap” also highlights time-saving, but at the same time, highlights cost-saving. Therefore, the advertising slogan “Easy and cheap” is categorized into a cluster different from the entry 6.

As a result, in the webpage, an image of an egg dish of the recommended product P2 and an image of curry with rice of the recommended product P3 are arranged along with the entry 6 “For busy people”. Obviously, an advertising slogan corresponding to a recommended product may be displayed along with an image of the recommended product in a webpage.

As a method for categorizing advertising slogans according to taste, cluster analysis is performed in the above explanation. However, a known categorizing method for categorizing advertising slogans with similar tastes may be used. For example, the similarity between the entry 6 and an advertising slogan may be measured using a cosine distance between the entry 6 and the advertising slogan. An image of a recommended product associated with an advertising slogan close to contents of the entry 6 may be displayed along with the entry 6. Furthermore, the similarity between the entry 6 and an advertising slogan may be measured using a similarity estimation model that outputs the similarity of text as a numerical value.

In the example provided above, the entry 6 is set in advance. However, the CPU 21 may generate the entry 6 by summarizing each of the advertising slogans included in the cluster identified in step S410 of FIG. 9.

In contrast, in the case where a product recommendation model that has performed machine learning such that in the case where user information is input, a plurality of recommended products recommended to a user represented by the input user information are output is available, the CPU 21 may arrange the recommended products in a webpage for a specified user according to a recommendation order of the recommended products output from the product recommendation model.

In this case, the CPU 21 may receive an advertising slogan prepared for each of the recommended products output from the product recommendation model and change the arrangement of the recommended products such that the recommended products are arranged in descending order of purchase probability in the case where the advertising slogans are added to the recommended products, that is, in descending order of score output from the learning model 18. Because the advertising slogans are arranged in consideration of purchase probability, the purchase probability of a recommended product increases compared to a case where recommended products are arranged according to the order of recommendation output from the product recommendation model.

The present disclosure has been explained with reference to exemplary embodiments. However, the scope of the present disclosure is not limited to the exemplary embodiments. Various changes or improvements may be made to the exemplary embodiments without departing from the scope of the present disclosure. Modes in which the changes or improvements have been made are also included in the technical scope of the present disclosure. For example, the order of processing operations may be changed without departing from the scope of the present disclosure.

In each of the exemplary embodiments, a mode in which each process is implemented by software has been explained as an example. However, processes equivalent to the flowcharts illustrated in FIGS. 4 to 6, 8, and 9 may be implemented in, for example, an application specific integrated circuit (ASIC), a field programmable gate array (FPGA), or a programmable logic device (PLD) and processed by hardware. In this case, compared to the case where each process is implemented by software, the process may be performed at high speed.

As described above, the CPU 21 may be replaced with a dedicated processor specialized for a specific process, such as the ASIC, the FPGA, the PLD, a graphics processing unit (GPU), or a floating point unit (FPU).

An operation of the CPU 21 in each of the exemplary embodiments may be implemented by a single CPU 21 or a plurality of CPUs 21. Furthermore, an operation of the CPU 21 in each of the exemplary embodiments may be implemented in corporation of the CPU 21 in the computer 20 that is located in a physically distant location.

Furthermore, in each of the exemplary embodiments described above, a mode in which a generation program is installed in the ROM 22 has been explained. However, the present disclosure is not limited to this. A generation program according an exemplary embodiment of the present disclosure may be recorded in a computer-readable recording medium and provided. For example, a generation program may be recorded in an optical disc such as a compact disc-read only memory (CD-ROM) or a digital versatile disc-read only memory (DVD-ROM) and provided. Furthermore, a generation program according to an exemplary embodiment of the present disclosure may be recorded in a portable semiconductor memory such as a USB memory or a memory card and provided.

Furthermore, the generation device 10 and the generation device 10A may acquire a generation program according to an exemplary embodiment of the present disclosure via the communication unit 27 from an external device connected to the Internet.

In the embodiments above, the term “processor” refers to hardware in a broad sense. Examples of the processor includes general processors (e.g., CPU: Central Processing Unit), dedicated processors (e.g., GPU: Graphics Processing Unit, ASIC: Application Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. A generation device comprising:
a processor configured to
input user information of a user and product information of a recommended product recommended to the user into a learning model that has learned, using learning data in which the user information of the user, a purchase history of the user regarding a product, product information of the product, and text associated with the product, the text being added to the product, are associated with one another, association of the user information, the purchase history, the product information, and the text included in the learning data, and
generate text associated with the recommended product based on the purchase history of the user.

2. The generation device according to claim 1,
wherein the processor
receives a plurality of text candidates,
inputs, for each of the received text candidates, a combination of the received text candidate, the user information of the user, and the product information of the recommended product into the learning model, and
generates text with the highest degree of response of the user, among the received text candidates, as the text associated with the recommended product.

3. The generation device according to claim 1,
wherein the purchase history used to generate the learning data indicates that the product has been purchased, and
wherein the processor inputs the user information of the user and the product information of the recommended product into the learning model and generates the text associated with the recommended product based on the purchase history of the user.

4. The generation device according to claim 2,
wherein the purchase history of the user is a history in which purchase or non-purchase of the product and a process of purchase of the product are recorded, and
wherein the degree of response is represented by a purchase probability of the recommended product.

5. The generation device according to claim 4,
wherein the processor sets the degree of interest of the user in the product, based on the recorded process of purchase of the product, and reflects the degree of interest of the user in the product in learning of the learning data.

6. The generation device according to claim 1,
wherein the processor performs learning of the learning model using the learning data for the user, the learning data including user information of a different user for whom at least one of a similarity with the user information of the user and a similarity with a tendency of purchase of the product is equal to or higher than a predetermined similarity.

7. The generation device according to claim 2,
wherein the processor performs learning of the learning model using the learning data for the user, the learning data including user information of a different user for whom at least one of a similarity with the user information of the user and a similarity with a tendency of purchase of the product is equal to or higher than a predetermined similarity.

8. The generation device according to claim 1,
wherein the processor generates the text associated with the recommended product such that a constraint regarding a preference of the user is satisfied.

9. The generation device according to claim 2,
wherein the processor generates the text associated with the recommended product such that a constraint regarding a preference of the user is satisfied.

10. The generation device according to claim 8,
wherein the processor estimates, based on the number of characters of the text associated with the product added to the product and the purchase history of the user, the number of characters of the text associated with the product whose purchase probability is equal to or higher than a predetermined probability, and generates the text associated with the recommended product whose number of characters is close to the estimated number of characters.

11. The generation device according to claim 9,
wherein the processor estimates, based on the number of characters of the text associated with the product added to the product and the purchase history of the user, the number of characters of the text associated with the product whose purchase probability is equal to or higher than a predetermined probability, and generates the text associated with the recommended product whose number of characters is close to the estimated number of characters.

12. The generation device according to claim 8,
wherein the processor estimates, based on a character form of the text associated with the product added to the product and the purchase history of the user, at least one attribute among color, font, and size of the text associated with the product, and generates the text associated with the recommended product such that at least one attribute among color, font, and size of the text associated with the recommended product is the same as the estimated attribute.

13. The generation device according to claim 9,
wherein the processor estimates, based on a character form of the text associated with the product added to the product and the purchase history of the user, at least one attribute among color, font, and size of the text associated with the product, and generates the text associated with the recommended product such that at least one attribute among color, font, and size of the text associated with the recommended product is the same as the estimated attribute.

14. The generation device according to claim 1,
wherein the processor generates the text associated with the recommended product such that a constraint regarding display on a medium on which the text associated with the recommended product is displayed is satisfied.

15. The generation device according to claim 2,
wherein the processor generates the text associated with the recommended product such that a constraint regarding display on a medium on which the text associated with the recommended product is displayed is satisfied.

16. The generation device according to claim 14,
wherein the processor generates the text associated with the recommended product such that the number of characters is smaller than or equal to the maximum number of characters set according to a size of a region in which text is to be displayed on the medium.

17. The generation device according to claim 14,
wherein the processor generates, as the text associated with the recommended product, text whose similarity with existing text that has already been displayed on the medium is lower than a reference similarity.

18. The generation device according to claim 14,
wherein the processor generates, as the text associated with the recommended product, text categorized into the same category as text displayed together on the medium.

19. The generation device according to claim 1,
wherein the processor
inputs, instead of the text associated with the product included in the learning data, text generated by a generation model that has performed machine learning such that the text associated with the product is generated based on text regarding the product, into the learning model, and
causes the generation model to perform learning, by causing loss representing an error between a purchase probability output from the learning model and a possible maximum purchase probability to be backward propagated to the generation model, such that text in which the loss is small is generated.

20. A non-transitory computer readable medium storing a program causing a computer to execute a process for generation, the process comprising:
inputting user information of a user and product information of a recommended product recommended to the user into a learning model that has learned, using learning data in which the user information of the user, a purchase history of the user regarding a product, product information of the product, and text associated with the product, the text being added to the product, are associated with one another, association of the user information, the purchase history, the product information, and the text included in the learning data, and
generating text associated with the recommended product based on the purchase history of the user.
